(19) United States
(12) Patent Application Publication
(10) Pub. No.: US 2026/0074790 A1
(43) Pub. Date: Mar. 12, 2026

(54) EVENT TIMING-BASED METHOD AND APPARATUS FOR FIBER-OPTIC FREQUENCY TRANSFER

(71) Applicants: JINAN INSTITUTE OF QUANTUM TECHNOLOGY, Jinan (CN); HEFEI NATIONAL LABORATORY, Hefei (CN)

(72) Inventors: Faxi CHEN, Jinan (CN); Libo LI, Hefei (CN); Kan ZHAO, Hefei (CN); Yubo XIN, Hefei (CN); Xianbin SHAO, Hefei (CN); Pingan MA, Hefei (CN); Jia SUN, Hefei (CN); Chuanxiang WU, Hefei (CN); Haifeng JIANG, Hefei (CN)

(73) Assignees: JINAN INSTITUTE OF QUANTUM TECHNOLOGY, Jinan (CN); HEFEI NATIONAL LABORATORY, Hefei (CN)

(21) Appl. No.: 19/255,956

(22) Filed: Jun. 30, 2025

(30) Foreign Application Priority Data
Sep. 10, 2024 (CN) 202411263296.6

(51) Int. Cl. H04B 10/2543; H04B 10/50

(52) U.S. Cl. CPC H04B 10/2543; H04B 10/503

(57) ABSTRACT

An event timing-based method and apparatus for fiber-optic frequency transfer are provided, relating to the fields of time-frequency transfer and precision time measurement. According to the method, an event timer is used to detect a time stamp of each rising edge of a radio frequency (RF) signal, which reflects a link delay jitter, a reference time stamp is subtracted from the time stamp to obtain a phase error, and an actuator is driven to compensate the phase error, thereby improving tolerance of a system to link noise while ensuring the stability of optical frequency transfer. Thus, the link delay jitter is suppressed, ensuring that a phase of an output transferred beam remains in long-term stability with a phase of an input reference light.

### CROSS-REFERENCE TO RELATED APPLICATIONS

The present application claims priority to Chinese Patent Application No.202411263296.6, titled “EVENT TIMING-BASED METHOD AND APPARATUS FOR FIBER-OPTIC FREQUENCY TRANSFER”, filed on Sep. 10, 2024 with the China National Intellectual Property Administration, which is incorporated herein by reference in its entirety.

### FIELD

The present disclosure relates to the fields of time-frequency transfer and precision time measurement, and in particular to an event timing-based method and apparatus for fiber-optic frequency transfer.

### BACKGROUND

In the field of optical frequency transfer, optical fiber links serve as a main medium for signal transmission, and their stability and reliability are crucial for high-precision time synchronization and frequency transfer. In practice, optical fiber links are often subjected to significant noise interference resulting from complex environmental factors such as laying overhead and along railways. The wavelength of a laser beam is typically around 1550 nanometers (nm), and the period of an optical frequency signal is extremely short, approximately 5 femtoseconds (fs). Consequently, a minute jitter on a link may cause a substantial change in the phase of an optical wave, which may exceed tens of thousands of periods. This large phase change places extremely high requirements on the detection capability of optical frequency transfer systems.

Currently, mainstream optical frequency transfer solutions rely on phase detectors to precisely detect phase errors, but a conventional phase detector has a relatively limited detection range, typically within half a period (±1 period). To address out-of-range phase errors caused by link noise, according to a conventional method, a high-ratio frequency divider is introduced before phase detection to expand an effective detection range of the phase detector by reducing signal frequencies. Although the method is capable of reducing phase error overflowing the detection range, it produces substantial undesirable impacts.

Frequency division processing increases system delay, which directly reduces a locking bandwidth of a loop, that is, the speed at which the system responds to phase changes decreases. Furthermore, frequency division processing reduces sensitivity of phase error detection, making it more difficult for the system to capture tiny phase fluctuations. These adverse factors together severely reduce the stability and precision of optical frequency transfer systems. Especially in high-noise link environments, the systems may encounter loss of synchronization due to excessive phase errors, and even fail to maintain a locked state, consequently leading to rapid degradation in stability of optical frequency transfer.

### SUMMARY

In view of the above, an event timing-based method for fiber-optic frequency transfer is provided in the present disclosure. The method includes the following description.

In one embodiment, an event timing-based method for fiber-optic frequency transfer is provided in the present disclosure, and the method includes:
splitting a reference beam generated at a sending end into a first laser beam and a second laser beam via a beam splitter;
performing frequency modulation on the first laser beam by an acousto-optic modulator (AOM), and transmitting the first laser beam after the frequency modulation to a receiving end through an optical fiber link;
splitting the first laser beam into a third laser beam and a fourth laser beam by a semi-reflective and semi-transmissive Faraday rotator mirror at the receiving end, where the third laser beam is outputted as a transferred beam after passing through the semi-reflective and semi-transmissive Faraday rotator mirror, and the fourth laser beam is reflected by the semi-reflective and semi-transmissive Faraday rotator mirror to pass through the optical fiber link, the AOM and the beam splitter to reach a photodetector;
reflecting, by a Faraday rotator mirror, the second laser beam to enter the photodetector to beat with the fourth laser beam reflected by the semi-reflective and semi-transmissive Faraday rotator mirror to generate a beat signal;
acquiring a timestamp of a rising edge of the beat signal, where the timestamp is recorded by an event timer;
obtaining phase error data based on the timestamp of the rising edge of the beat signal and a reference timestamp; and
performing phase compensation on the optical fiber link based on the phase error data.

In an embodiment, before the acquiring a timestamp of a rising edge of the beat signal, the method further includes:
performing noise filtering on the beat signal generated in the photodetector; and
amplifying the noise-filtered beat signal, converting the amplified signal into a square wave signal and inputting the square wave signal to the event timer.

In an embodiment, the event timer and a module for generating the reference timestamp share a common radio frequency (RF) reference signal.

In an embodiment, the obtaining phase error data based on the timestamp of the rising edge of the beat signal and a reference timestamp includes:
acquiring a timestamp Tₚᵢ of a rising edge of the beat signal in the event timer;
acquiring a reference timestamp Tᵣᵢ in a reference timestamp module; and
calculating the phase error data by using a calculation formula for a phase error Pₑᵢ, where the calculation formula for the phase error Pₑᵢ is expressed as Pₑᵢ=(Tₚᵢ−Tᵣᵢ)/2.

In an embodiment, the performing phase compensation on the optical fiber link based on the phase error data includes:
inputting the phase error data as a phase error signal to a digital proportional-integral (PI) controller;
calculating, based on the phase error signal, a frequency adjustment amount by the digital PI controller through internal proportional and integral logic of the digital PI controller;
converting, by a digital-to-analog converter (DAC) module, the frequency adjustment amount into an analog signal to output a corresponding voltage signal;
receiving, by a voltage-controlled oscillator (VCO), the voltage signal from the DAC module, and adjusting, by the VCO, a frequency of an output signal of the VCO based on the voltage signal; and
amplifying the output signal of the VCO by using a radio frequency (RF) power amplifier to obtain an amplified RF signal, and driving the AOM using the amplified RF signal, to implement the phase compensation on the optical fiber link.

In one embodiment, an event timing-based apparatus for fiber-optic frequency transfer is provided according to the present disclosure, and the apparatus includes a sending end and a receiving end.

The sending end includes a reference beam input end, a beam splitter, an acousto-optic modulator (AOM), a photodetector, a Faraday rotator mirror, an event timer, a reference timestamp module and a phase compensation module.

The reference beam input end is configured to generate a reference beam.

The beam splitter is configured to split the reference beam into a first laser beam and a second laser beam.

The AOM is configured to perform frequency modulation on the first laser beam, where the first laser beam after the frequency modulation is transmitted to the receiving end through an optical fiber link, and is split into a third laser beam and a fourth laser beam at the receiving end.

The receiving end includes a semi-reflective and semi-transmissive faraday rotator mirror.

The semi-transmissive Faraday rotator mirror is configured to split the first laser beam into the third laser beam and the fourth laser beam, and the third laser beam is outputted as a transferred beam after passing through the semi-reflective and semi-transmissive Faraday rotator mirror, the fourth laser beam is reflected by the semi-reflective and semi-transmissive Faraday rotator mirror to pass through the optical fiber link, the AOM and the beam splitter to reach the photodetector.

The Faraday rotator mirror is configured to reflect the second laser beam to enter the photodetector to beat with the fourth laser beam reflected by the semi-reflective and semi-transmissive Faraday rotator mirror to generate a beat signal.

The photodetector is configured to generate the beat signal.

The event timer is configured to record a timestamp of a rising edge of the beat signal, and phase error data is obtained based on the timestamp of the rising edge of the beat signal and a reference timestamp generated by the reference timestamp module.

The phase compensation module is configured to perform phase compensation on the optical fiber link based on the phase error data.

In an embodiment, the sending end further includes a signal conditioning module.

The signal conditioning module is configured to perform noise filtering on the beat signal generated by the photodetector before the timestamp of the rising edge of the beat signal recorded by the event timer is acquired, amplify the noise-filtered beat signal, and convert the amplified signal into a square wave signal to input the square wave signal to the event timer.

In an embodiment, the sending end further includes a radio frequency (RF) reference module, and the RF reference module is configured to generate a RF signal to be applied to the event timer and the reference timestamp module.

In an embodiment, for obtaining the phase error data based on the timestamp of the rising edge of the beat signal and the reference timestamp generated by the reference timestamp module, the apparatus is configured to:
acquire a timestamp Tₚᵢ of a rising edge of the beat signal in the event timer, acquire a reference timestamp Tᵣᵢ in the reference timestamp module, and calculate the phase error data by using a calculation formula for a phase error Pₑᵢ, where the calculation formula for the phase error Pₑᵢ is expressed as Pₑᵢ=(Tₚᵢ−Tᵣᵢ)/2.

In an embodiment, the phase compensation module includes a digital proportional-integral (PI) controller, a digital-to-analog converter (DAC) module, a voltage-controlled oscillator (VCO) and a radio frequency (RF) power amplifier.

For performing phase compensation on the optical fiber link,
the phase error data is inputted as a phase error signal to the digital PI controller;
the digital PI controller is configured to calculate, based on the phase error signal, a frequency adjustment amount through internal proportional and integral logic of the digital PI controller;
the DAC module is configured to convert the frequency adjustment amount into an analog signal to output a corresponding voltage signal;
the VCO is configured to receive the voltage signal from the DAC module, and adjust a frequency of an output signal of the VCO based on the voltage signal; and
the RF power amplifier is configured to amplify the output signal of the VCO to obtain an amplified RF signal, and the AOM is driven by the amplified RF signal to implement the phase compensation on the optical fiber link.

An event timing-based method for fiber-optic frequency transfer is provided in the present disclosure. During implementation of the method, a reference beam generated at a sending end is split into a first laser beam and a second laser beam via a beam splitter. After passing through the AOM and an optical fiber link, the first laser beam is transmitted to the receiving end, and the first laser beam is split into a third laser beam and a fourth laser beam by the semi-reflective and semi-transmissive Faraday rotator mirror at the receiving end. The third laser beam is outputted as a transferred beam after passing through the semi-reflective and semi-transmissive Faraday rotator mirror. The fourth laser beam is reflected by the semi-reflective and semi-transmissive Faraday rotator mirror and then passes again through the optical fiber link, the AOM and the beam splitter to reach the photodetector. The second laser beam is reflected by the Faraday rotator mirror to enter the photodetector, to beat with the fourth laser beam reflected by the FM2 to generate a beat signal. A timestamp of a rising edge of the beat signal recorded by the event timer is acquired. Phase error data is obtained based on the timestamp of the rising edge of the beat signal and a reference timestamp. Phase compensation is performed for the optical fiber link based on the phase error data. According to the method, the event timer is employed to directly detect the phase error of an RF signal, which reflects a link delay jitter, the beat signal is detected to extract an error signal, and an actuator is driven to directly compensate for the phase error, improving the tolerance of the system to link noise while ensuring the stability of the optical frequency transfer.

### BRIEF DESCRIPTION OF THE DRAWINGS

In order to more clearly describe the embodiments of the present disclosure or in the conventional technology, the drawings to be used in the description of the embodiments or the conventional technology are briefly described below. Apparently, the drawings described in the following description show only some embodiments of the present disclosure, and other drawings may be obtained.

FIG. 1 is a flowchart of an event timing-based method for fiber-optic frequency transfer according to an embodiment of the present disclosure;

FIG. 2 is a structural diagram of an event timing-based system for fiber-optic frequency transfer according to an embodiment of the present disclosure; and

FIG. 3 is a schematic structural diagram of an event timing-based apparatus for fiber-optic frequency transfer according to an embodiment of the present disclosure.

### DETAILED DESCRIPTION

In order to make the embodiments of the present disclosure more clear, embodiments of the present disclosure are clearly and completely described hereinafter in conjunction with the drawings of the embodiments of the present disclosure. Apparently, the embodiments described are only some embodiments of the present disclosure, rather than all embodiments. Any other embodiments obtained in the art based on the embodiments in the present disclosure fall within the protection scope of the present disclosure.

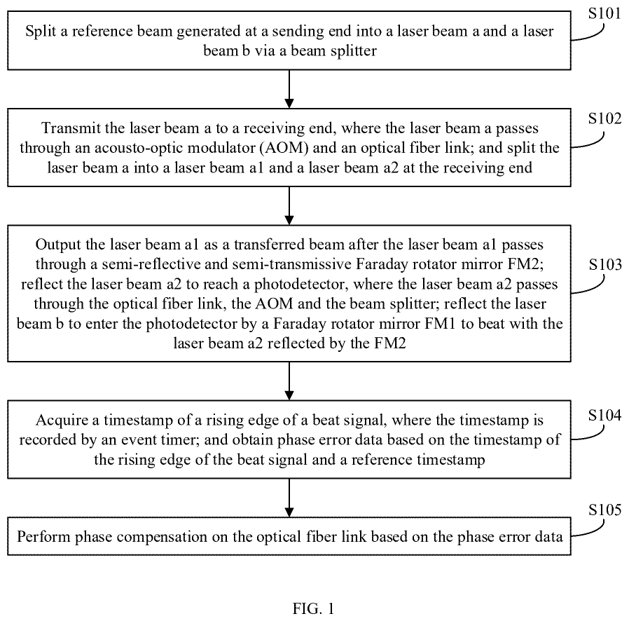

FIG. 1 is a flowchart of an event timing-based method for fiber-optic frequency transfer according to an embodiment in the present disclosure. Referring to FIG. 1, the event timing-based method for fiber-optic frequency transfer provided according to the embodiment of the present disclosure may include steps S101 to S105.

In step S101, a reference beam generated at a sending end is split into a laser beam a and a laser beam b via a beam splitter.

In order to more clearly introduce the method in the embodiment of the present disclosure, a structural diagram of an event timing-based system for fiber-optic frequency transfer is provided according to the embodiment of the present disclosure. Referring to FIG. 2, FIG. 2 is a structural diagram of the event timing-based system for fiber-optic frequency transfer according to an embodiment of the present disclosure. The system shown in FIG. 2 includes the sending end and a receiving end.

The sending end includes: a reference beam input end, a beam splitter, an acousto-optic modulator (AOM), a photodetector, a Faraday rotator mirror FM1, an event timer, a reference timestamp module, a phase compensation module and a signal conditioning module. The phase compensation module includes a digital PI controller, a digital-to-analog converter (DAC) module, a voltage-controlled oscillator (VCO) and a radio frequency (RF) power amplifier. The receiving end includes a semi-reflective and semi-transmissive Faraday rotator mirror FM2.

The reference beam is inputted to the sending end through the reference beam input end, and then is split via the beam splitter. In an embodiment of the present disclosure, a wavelength of the reference beam is exemplified. A laser beam emitted by a 1550.12 nm narrow-linewidth single-frequency laser serves as the reference beam and is inputted to a 1550 nm X-beam splitter. The beam splitter is an optical component configured to split one beam into two or more beams and is commonly used in optical experiments and communication systems. In the embodiment of the present disclosure, one reference beam is split into two laser beams, which are a laser beam a and a laser beam b, by the beam splitter. The two laser beams enter different processing paths.

In step S102, after passing through the AOM and an optical fiber link, the laser beam a is transmitted to the receiving end, and the laser beam a is split into a laser beam a1 and a laser beam a2 at the receiving end.

The acousto-optic modulator (AOM) is an apparatus which implements frequency modulation, deflection, or intensity modulation of a light beam by changing a refractive index of the light beam in a medium based on interaction between a sound wave and a light wave.

The optical fiber link is a communication link formed by optical fibers, and is configured to transmit optical signals. The optical fiber link has advantages of high bandwidth, low loss, resistance to electromagnetic interference and the Like.

The laser beam a is frequency-modulated via the AOM, and the frequency-modulated laser beam a is transmitted to the receiving end over the optical fiber link. At the receiving end, the laser beam a is further split into two beams: the laser beam a1 and the laser beam a2, where the splitting is implemented by the semi-reflective and semi-transmissive Faraday rotator mirror FM2.

In step S103, the laser beam a1 is outputted as a transferred beam after passing through the semi-reflective and semi-transmissive Faraday rotator mirror FM2. The laser beam a2 is reflected by the semi-reflective and semi-transmissive Faraday rotator mirror FM2 and then passes again through the optical fiber link, the AOM and the beam splitter to reach the photodetector. The laser beam b is reflected by the Faraday rotator mirror FM1 to enter the photodetector, to beat with the laser beam a2 reflected by the FM2.

Transmission of the laser beam a1 is implemented as follows. The laser beam a1 passes through the semi-reflective and semi-transmissive Faraday rotator mirror FM2, during which a polarization state of the laser beam a1 is adjusted, and is outputted as a transferred beam for subsequent optical processing or communication.

The feedback loop of the laser beam a2 is implemented in the following process. The laser beam a2 is reflected to return along the original optical fiber link, then the reflected laser beam a2 passes through the AOM and the beam splitter, and ultimately reaches the photodetector. In this process, the laser beam a2 is transmitted twice over the optical fiber and modulated twice by the AOM, leading to a phase change of the laser beam a2.

Introduction and the beats of the laser beam b are implemented as follows. The laser beam b is reflected by the Faraday rotator mirror FM1 (or a similar rotation mirror), during which the polarization state of the beam b is adjusted, and enters the photodetector. In the photodetector, the laser beam b beats with the laser beam a2 returned from the feedback loop and generates a beat signal.

The beat signal refers to a frequency difference signal generated when two waves with similar frequencies interfere with each other. In optics, beat signals are often applied in measurement of a frequency differences or phase differences of light waves.

In step S104, a timestamp of a rising edge of the beat signal is acquired, and the timestamp is recorded by the event timer. Phase error data is obtained based on the timestamp of the rising edge of the beat signal and a reference timestamp.

The event timer is a high-precision time measurement device configured to record event occurrence timestamps and is commonly used for time synchronization and precise time measurement. In practice, a signal acquisition process may be subjected to interference of various noises, and thus filtering is performed on the signal before acquiring the timestamp of the rising edge of the beat signal recorded by the event timer. In an embodiment, noise filtering is performed on the beat signal generated in the photodetector, the processed beat signal is amplified into a square wave signal, and the square wave signal is inputted to the event timer.

In order to ensure high precision and synchronization of the time measurement, the event timer and a module generating the reference timestamp share a common radio frequency (RF) reference signal in the embodiment of the present disclosure. The common RF reference signal not only provides a stable and consistent time reference for both the event timer and the module, but also enables them to work collaboratively to more precisely record and analyze the timestamp of the rising edge of the beat signal.

The acquiring phase error data based on the timestamp of the rising edge of the beat-frequency signal and a reference timestamp includes:

acquiring a timestamp Tₚᵢ of a rising edge of the beat signal in the event timer, acquiring a reference timestamp Tᵣᵢ in the reference timestamp module, and calculating the phase error data by using a calculation formula for a phase error Pₑᵢ, where the calculation formula for the phase error Pₑᵢ is expressed as Pₑᵢ=(Tₚᵢ−Tᵣᵢ)/2.

The reference timestamp is generated as follows. Assuming that a nominal operating frequency of the AOM is F_{AOM} and a frequency of the beat signal when the optical fiber link is noiseless is F_{bref}, F_{bref}=2F_{AOM}. The reference timestamp is incremented by 1/F_{bref} each time when the rising edge of the beat signal is reached.

Assuming that F_{AOM}=50 MHz, F_{bref}=100 MHz. In a case where the measurement precision of the event timer for the RF signal is 20 ps and a frequency of an optical frequency signal is 1550 nm, the measurement resolution for a phase of the optical frequency signal is about 0.01 fs.

In Step S105, phase compensation is performed for the optical fiber link based on the phase error data.

The phase error data is inputted to the digital PI controller as a phase error signal. The digital PI controller calculates a frequency adjustment amount based on the phase error signal through internal proportional and integral logic of the digital PI controller. The DAC module converts the frequency adjustment amount into an analog signal to output a corresponding voltage signal. The VCO receives the voltage signal from the DAC module and adjusts the frequency of an output signal based on the voltage signal. The output signal outputted by the VCO module is amplified by an RF power amplifier to obtain an amplified RF signal, and the amplified RF signal is configured to drive the AOM to implement phase compensation on the optical fiber link.

Phase error data Pₑᵢ serves as an input signal to be fed into the digital PI (proportional-integral) controller. The PI controller is a commonly used algorithm in a control system, and is configured to adjust a control variable based on the error signal to reduce errors. In the PI controller, the input phase error signal is processed through proportional (P) and integral (I) logic. The proportional term is configured to respond immediately to errors, while the integral term is configured to eliminate steady-state errors in the system. The PI controller calculates the required frequency adjustment by combining these two types of logic. The calculated frequency adjustment amount (generally a digital signal) is converted into an analog signal to control an analog circuit. The conversion may be implemented by the digital-to-analog converter (DAC) module. The DAC module receives a digital signal and outputs an analog voltage or a current signal corresponding to the digital signal.

The VCO is an oscillator that changes the frequency of the output signal based on an input voltage. The VCO receives the voltage signal from the DAC module and adjusts the frequency of the output signal of the VCO based on the voltage signal. In the system, an output frequency of the VCO is configured to compensate for phase errors in the optical fiber link. Since the signal outputted by the VCO may not be sufficient to drive the AOM, the output signal is amplified by the RF power amplifier. The RF power amplifier increases a power level of the output signal, enabling the amplified signal to drive the AOM to produce a desired optical modulation effect.

The amplified RF signal is configured to drive the AOM. The AOM introduces a controllable phase delay by changing the frequency of a light wave. The phase delay is configured to compensate for the phase error in the optical fiber link caused by various factors (such as temperature change, mechanical stress and the like).

Through the above steps, the phase compensation module detects and compensates for the phase error in the optical fiber link in a real time manner. In response to a detected phase error, the PI controller calculates the required frequency adjustment amount, and adjusts a driving signal for the AOM via modules such as the VCO and the RF power amplifier. Thus, the phase delay of the light wave in the optical fiber link is adjusted, achieving the purpose of phase compensation. The process is closed-loop, meaning that the system continuously performs monitoring and adjustment to keep the phase stable in the optical fiber link.

The above describes some implementations of the event timing-based method for fiber-optic frequency transfer according to embodiments of the present disclosure. In view of this, an apparatus corresponding to the method is further provided. Hereinafter, the apparatus provided according to embodiments of the present disclosure is introduced from the perspective of functional modularization.

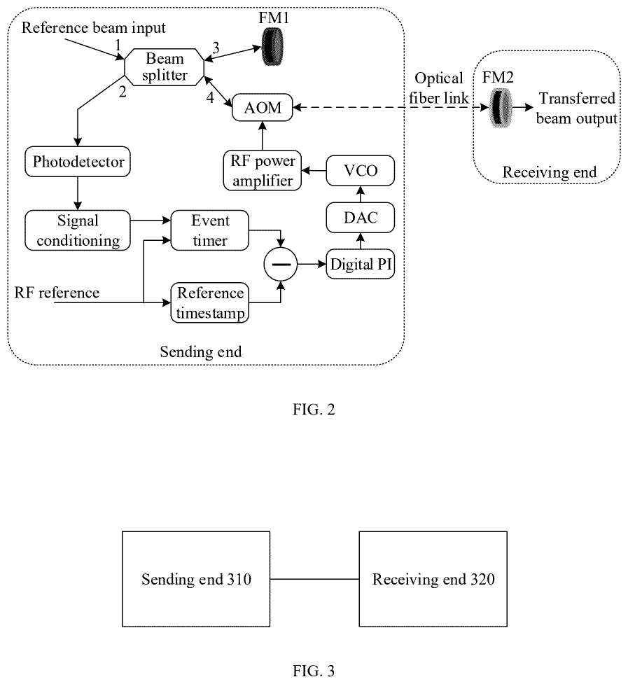

FIG. 3 is a schematic structural diagram of an event timing-based apparatus for fiber-optic frequency transfer according to an embodiment of the present disclosure. Referring to FIG. 3, the event timing-based apparatus for fiber-optic frequency transfer according to embodiments in the present disclosure includes a sending end 310 and a receiving end 320.

The sending end includes a reference beam input end, a beam splitter, an AOM, a photodetector, a Faraday rotator mirror FM1, an event timer, a reference timestamp module and a phase compensation module.

In a case where the reference beam input end generates a reference beam, the reference beam is split into a laser beam a and a laser beam b via the beam splitter.

The laser beam a is transmitted to the receiving end after passing through the AOM and an optical fiber link, and is split into a laser beam a1 and a laser beam a2 at the receiving end.

The receiving end includes a semi-reflective and semi-transmissive Faraday rotator mirror FM2. The laser beam a1 is output as a transferred beam after passing through the semi-reflective and semi-transmissive Faraday rotator mirror FM2. The laser beam a2 is reflected and then passes through the optical fiber link, the AOM and the beam splitter to reach the photodetector. The laser beam b is reflected by the Faraday rotator mirror FM1 to enter the photodetector to beat with the laser beam a2 reflected by FM2 to generate a beat signal.

The event timer is configured to record a timestamp of a rising edge of the beat signal. Phase error data is obtained based on the timestamp of the rising edge of the beat signal and a reference timestamp generated by the reference timestamp module.

The phase compensation module is configured to perform phase compensation on the optical fiber link based on the phase error data.

In an implementation of the embodiments of the present disclosure, the sending end further includes a signal conditioning module. The signal conditioning module is configured to perform, before the timestamp of the rising edge of the beat signal recorded by the event timer is acquired, noise filtering on the beat signal outputted by the photodetector.

The noise-filtered beat signal is amplified and converted into a square wave signal and the square wave signal is inputted to the event timer.

In an implementation of the embodiments of the present disclosure, the sending end further includes an RF reference module. The RF reference module is configured to generate an RF signal, and the RF signal is applied to the event timer and the reference timestamp module.

In an implementation of the embodiments of the present disclosure, for obtaining phase error data based on the timestamp of the rising edge of the beat signal and a reference timestamp generated by the reference timestamp module, the apparatus is further configured to:
acquire a timestamp Tₚᵢ of a rising edge of the beat signal in the event timer, acquire a reference timestamp Tᵣᵢ in a reference timestamp module, and calculate the phase error data by using a calculation formula for a phase error Pₑᵢ, where the calculation formula for the phase error Pₑᵢ is expressed as Pₑᵢ=(Tₚᵢ−Tᵣᵢ)/2.

In an implementation of the embodiments of the present disclosure, the phase compensation module includes a digital PI controller, a DAC module, a VCO and an RF power amplifier. For performing phase compensation on the optical fiber link by the phase compensation module,
the phase error data is inputted as a phase error signal to the digital PI controller;
the digital PI controller is configured to calculate, based on the phase error signal, a frequency adjustment amount through internal proportional and integral logic of the digital PI controller;
the DAC module is configured to convert the frequency adjustment amount into an analog signal, and is controlled to output a corresponding voltage;
the VCO is configured to receive a voltage signal from the DAC module, and adjust a frequency of an output signal of the VCO based on the voltage signal; and
the RF power amplifier is configured to amplify the output signal of the VCO to obtain an amplified RF signal, and the AOM is driven by the amplified RF signal, to implement the phase compensation on the optical fiber link.

It should be noted that relationship terms such as “first” and “second” and the like are only used herein to distinguish one entity or operation from another, rather than to necessitate or imply that the actual relationship or order exists between the entities or operations. Moreover, terms of “include”, “comprise” or any other variants are intended to be non-exclusive. Therefore, a process, method, article, or device including multiple elements includes not only the elements but also other elements that are not enumerated, or also includes the elements inherent for the process, method, article or device. Unless expressively limited otherwise, the statement “comprising (including) one...” does not exclude the case that other similar elements may exist in the process, method, article or device.

It should be further noted that the embodiments in the present disclosure are described in a progressive manner, the same and similar parts of the various embodiments can be referred to each other, and each embodiment focuses on the differences from other embodiments. In particular, with respect to the device and apparatus embodiments, since they are fundamentally similar to the method embodiments, the description thereof is relatively simple. In some embodiments, reference may be made to the corresponding explanations in the method embodiments. The device embodiments and apparatus embodiments described above are merely schematic, where the units described as separate components may or may not be physically separated, and the components indicated as units may or may not be physical units, that is, they may be located in one position or may be distributed over multiple network units. Some or all of the modules therein may be selected according to actual needs to implement the objectives of the present embodiments.

The foregoing descriptions are merely embodiments of the present disclosure, and the scope of protection of the present disclosure is not limited thereto. Any modification or substitution readily conceivable in the art within the scope disclosed herein shall be encompassed within the scope of protection of the present disclosure. Therefore, the scope of protection of the present disclosure shall be determined by the scope of the claims.

1. An event timing-based method for fiber-optic frequency transfer, comprising:
splitting a reference beam generated at a sending end into a first laser beam and a second laser beam via a beam splitter;
performing frequency modulation on the first laser beam by an acousto-optic modulator (AOM), and transmitting the first laser beam after the frequency modulation to a receiving end through an optical fiber link;
splitting the first laser beam into a third laser beam and a fourth laser beam by a semi-reflective and semi-transmissive Faraday rotator mirror at the receiving end, wherein the third laser beam is outputted as a transferred beam after passing through the semi-reflective and semi-transmissive Faraday rotator mirror, and the fourth laser beam is reflected by the semi-reflective and semi-transmissive Faraday rotator mirror to pass through the optical fiber link, the AOM and the beam splitter to reach a photodetector;
reflecting, by a Faraday rotator mirror, the second laser beam to enter the photodetector to beat with the fourth laser beam reflected by the semi-reflective and semi-transmissive Faraday rotator mirror to generate a beat signal;
acquiring a timestamp of a rising edge of the beat signal, wherein the timestamp is recorded by an event timer;
obtaining phase error data based on the timestamp of the rising edge of the beat signal and a reference timestamp; and
performing phase compensation on the optical fiber link based on the phase error data.

2. The method according to claim 1, wherein, before the acquiring a timestamp of the rising edge of a beat signal, the method further comprises:
performing noise filtering on the beat signal generated in the photodetector; and
amplifying the noise-filtered beat signal, converting the amplified signal into a square wave signal and inputting the square wave signal to the event timer.

3. The method according to claim 1, wherein the event timer and a module for generating the reference timestamp share a common radio frequency (RF) reference signal.

4. The method according to claim 1, wherein the obtaining phase error data based on the timestamp of the rising edge of the beat signal and a reference timestamp comprises:
acquiring a timestamp Tₚᵢ of a rising edge of the beat signal in the event timer;
acquiring a reference timestamp Tᵣᵢ in a reference timestamp module; and
calculating the phase error data by using a calculation formula for a phase error Pₑᵢ, wherein the calculation formula for the phase error Pₑᵢ is expressed as Pₑᵢ=(Tₚᵢ−Tᵣᵢ)/2.

5. The method according to claim 1, wherein the performing phase compensation on the optical fiber link based on the phase error data comprises:
inputting the phase error data as a phase error signal to a digital proportional-integral (PI) controller;
calculating, based on the phase error signal, a frequency adjustment amount by the digital PI controller through internal proportional and integral logic of the digital PI controller;
converting, by a digital-to-analog converter (DAC) module, the frequency adjustment amount into an analog signal to output a corresponding voltage signal;
receiving, by a voltage-controlled oscillator (VCO), the voltage signal from the DAC module, and adjusting, by the VCO, a frequency of an output signal of the VCO based on the voltage signal; and
amplifying the output signal of the VCO by using a radio frequency (RF) power amplifier to obtain an amplified RF signal, and driving the AOM using the amplified RF signal, to implement the phase compensation on the optical fiber link.

6. An event timing-based apparatus for fiber-optic frequency transfer, comprising a sending end and a receiving end, wherein
the sending end comprises: a reference beam input end, a beam splitter, an acousto-optic modulator (AOM), a photodetector, a Faraday rotator mirror, an event timer, a reference timestamp module and a phase compensation module, wherein
the reference beam input end is configured to generate a reference beam;
the beam splitter is configured to split the reference beam into a first laser beam and a second laser beam,
the AOM is configured to perform frequency modulation on the first laser beam, wherein the first laser beam after the frequency modulation is transmitted to the receiving end through an optical fiber link, and is split into a third laser beam and a fourth laser beam at the receiving end; and
the receiving end comprises a semi-reflective and semi-transmissive Faraday rotator mirror, wherein the semi-transmissive Faraday rotator mirror is configured to split the first laser beam
into the third laser beam and the fourth laser beam, and the third laser beam is outputted as a transferred beam after passing through the semi-reflective and semi-transmissive Faraday rotator mirror, the fourth laser beam is reflected by the semi-reflective and semi-transmissive Faraday rotator mirror to pass through the optical fiber link, the AOM and the beam splitter to reach the photodetector, and
the Faraday rotator mirror is configured to reflect the second laser beam to enter the photodetector to beat with the fourth laser beam reflected by the semi-reflective and semi-transmissive Faraday rotator mirror to generate a beat signal;
the photodetector is configured to generate the beat signal;
the event timer is configured to record a timestamp of a rising edge of the beat signal, and phase error data is obtained based on the timestamp of the rising edge of the beat signal and a reference timestamp generated by the reference timestamp module; and
the phase compensation module is configured to perform phase compensation on the optical fiber link based on the phase error data.

7. The apparatus according to claim 6, wherein the sending end further comprises a signal conditioning module, and
the signal conditioning module is configured to perform noise filtering on the beat signal generated by the photodetector before the timestamp of the rising edge of the beat signal recorded by the event timer is acquired, amplify the noise-filtered beat signal, and convert the amplified signal into a square wave signal to input the square wave signal to the event timer.

8. The apparatus according to claim 6, wherein the sending end further comprises a radio frequency (RF) reference module, and the RF reference module is configured to generate an RF signal to be applied to the event timer and the reference timestamp module.

9. The apparatus according to claim 6, wherein for obtaining the phase error data based on the timestamp of the rising edge of the beat signal and the reference timestamp generated by the reference timestamp module, the apparatus is configured to:
acquire a timestamp Tₚᵢ of a rising edge of the beat signal in the event timer, acquire a reference timestamp Tᵣᵢ in the reference timestamp module, and calculate the phase error data by using a calculation formula for a phase error Pₑᵢ, wherein
the calculation formula for the phase error Pₑᵢ is expressed as Pₑᵢ=(Tₚᵢ-Tᵣᵢ)/2.

10. The apparatus according to claim 6, wherein the phase compensation module comprises a digital proportional-integral (PI) controller, a digital-to-analog converter (DAC) module, a voltage-controlled oscillator (VCO) and a radio frequency (RF) power amplifier, and for performing phase compensation on the optical fiber link,
the phase error data is inputted as a phase error signal to the digital PI controller;
the digital PI controller is configured to calculate, based on the phase error signal, a frequency adjustment amount through internal proportional and integral logic of the digital PI controller;
the DAC module is configured to convert the frequency adjustment amount into an analog signal to output a corresponding voltage signal;
the VCO is configured to receive the voltage signal from the DAC module, and adjust a frequency of an output signal of the VCO based on the voltage signal; and
the RF power amplifier is configured to amplify the output signal of the VCO to obtain an amplified RF signal, and the AOM is driven by the amplified RF signal to implement the phase compensation on the optical fiber link.
